(19) United States
(12) Patent Application Publication
(10) Pub. No.: US 2023/0321840 A1
(43) Pub. Date: Oct. 12, 2023

(54) BENDING TOOL FOR CONNECTION TO A TOOL EXCHANGE DEVICE MOUNTED ON A ROBOT

(71) Applicant: PMT Szerszámgép Kereskedelmi és Szerviz Zártköruen Muködo Részvénytársaság, Csongrád (HU)

(72) Inventors: Edvárd László KONCZ, Csongrád (HU); János PEKÁRIK, Kertész köz 1/A. (HU); István MAJOR, Csongrád (HU); Viktor SOMODI, Csongrád (HU)

(73) Assignee: PMT Szerszámgép Kereskedelmi és Szerviz Zártköruen Muködo Részvénytársaság, Csongrád (HU)

(21) Appl. No.: 18/295,883

(22) Filed: Apr. 5, 2023

(30) Foreign Application Priority Data
Apr. 8, 2022 (HU) 9844/22

(51) Int. Cl. B25J 15/00; B25J 15/04; B25J 11/00

(52) U.S. Cl. CPC B25J 15/0019; B25J 15/0491; B25J 11/005

(57) ABSTRACT

A bending tool with a shoulder, a tool holder groove and a clamping groove on the tool body is described. The bending tool has an oval bore going through the tool body below the shoulder. The tool holder groove side of the tool body has an oval seat extending into the oval through-bore, at the end of which, the end going into the tool body, is a flange extending vertically beyond the oval through-bore.

### CROSS REFERENCE APPLICATION

The present application claims the benefit of priority from the Hungarian Application No. 9844122 filed on Apr. 8, 2022, the entire content of each is incorporated herein by reference.

### BRIEF SUMMARY OF THE INVENTION

The subject of the invention is a bending tool for connection to a tool exchange device mounted on a robot, allowing the tool exchange device mounted on the robot to quickly and easily grip and move various types of bending tools, using the connection points retrofitted in the tools.

### BACKGROUND OF THE INVENTION

An essential step in the sheet metal working process is selecting the appropriate design for the upper and lower bending tools and inserting and clamping them in the tool holder, which should be done by a robot in high performance production systems. Currently, the devices developed for exchanging the bending tools in robotic bending machines are not designed to be compatible with all commercially available types of bending tools and their various clamping systems. Two thirds of the bending machines worldwide are marketed using a US (European Standard) tooling system, which is not compatible with any robotic solution, and the situation is similar for other types of bending tools as well. A considerable number of users are thus excluded from automation.

U.S. Pat. No. 7,632,224 B2, known from the state of the art, describes an exchangeable tool consisting of a tool body equipped with a receiving end, where the receiving end is used to secure the tool in a receiving device. Coupling elements are arranged in the tool body in such a way as to provide non-rotating connections for the manipulator that inserts the tool into and removes the tool from the receiving device.

U.S. Pat. No. 6,656,099 B1 describes a plate bending machine furnished with a bending tool and a tool exchange device equipped with a hook including a spline and a clench. The bending tool is equipped with a locking device supplemented with a clamping element. The bending machine constitutes a single unit with the upper and lower tool holders that are responsible for moving the bending tools. The tool exchange device transfers the bending tools into the tool clamp.

Different designs of commercially available bending tools can be found, inter alia, at URLs https://gordiuszalfa.hu/termek/rolleri-elhajilito-szerszamok/ and https.//www.toolsystems24. de/en/, where it can be seen that the tool bodies are not designed with a gripping solution allowing for attachment to a robotic gripping device. One such known solution is illustrated in FIGS. 1A and 1B, where the tool body of the bending tool 1 is furnished with a shoulder 1.1 supporting the tool holder, a tool holder groove 1.2 and a clamping groove 1.3: these structural parts are necessary to secure the bending tool 1 in a tool holder.

A drawback of the tools as described and used in practice is that they do not provide the operator with a workable solution for modifying the raw bending tool in order to allow the tool to be safely gripped and moved by a tool exchange device mounted on a robotic arm.

Having identified this deficiency, we set ourselves the task of retrofitting a gripping point on a bending tool of known state-of-the-art design, allowing the tool to be gripped and moved safely by a known tool exchange device mounted on a robotic arm.

### BRIEF DESCRIPTION OF THE FIGURES

Our invention is described in detail with reference to the accompanying drawings.

FIG. 1A shows a side view of the design of a known bending tool.

FIG. 1B shows a front view of the design of the edge bending tool illustrated in FIG. 1A.

FIG. 2A shows a front view of the gripping point design on a bending tool.

FIG. 2B shows the A-A sectional view of the bending tool illustrated in

FIG. 2A.

FIG. 2C shows a rear view of the design of the gripping point on a bending tool shown in FIG. 2A.

FIG. 3 shows the connection between the tool exchange device mounted on a robotic arm and the bending tool before clamping.

FIG. 4 shows a bending tool clamped on the robotic arm mounted tool exchange device.

### DETAILED DESCRIPTION OF THE INVENTION

A further task of the invention is the development of a bending tool on which the gripping point can subsequently be manufactured in a cost-effective way, while keeping the tool easy to use and maintain.

During the tests carried out during the design process, we recognized that a bending tool can only be gripped firmly by a robot and moved accurately via robotic control if the bending tool has an aperture for gripping, wherein the gripping structural element of the tool exchange device can be impacted against a support surface on the tool, and another structural element of the bending tool can be clamped onto the support surface providing the impact.

For our experiments, we used a robotic arm mounted tool exchange device, with a clamp stem that can be moved linearly back and forth by means of compressed air for clamping and releasing the bending tool.

With the set task in mind, the object of the invention is a bending tool that can be safely attached to a tool exchange device mounted on the robotic arm of a robot. The commercially available “raw” bending tool has a shoulder, a tool holder groove and a clamping groove on the tool body for mounting it in the tool holder. In order to allow attaching the tool to the tool exchange device, a gripping point is formed on the bending tool with an oval bore going through the tool body under the tool shoulder. The tool holder groove side of the tool body has an oval seat extending into the oval through-bore. At one end of the oval seat—the end going into the tool body—is a flange extending vertically beyond the oval through-bore. On the clamping groove side of the tool body, there is a conical seat with cylindrical end sections extending into the oval through-bore, the centre line of which intersects the flange above the upper edge of the oval through-bore.

The tool exchange device has a cylindrical clamp stem with a conical end, and a grip stem for picking up and clamping the bending tool. An oval support head for the holding the bending tool is attached to the end of the grip stem. This support head hits the flange of the bending tool's oval seat when the bending tool is gripped by the robot. Compressed air can be used to move the clamp stem linearly backwards and forwards, allowing it to extrude from or retract into the device. When the support head hits the flange of the oval seat on the bending tool and the conical end of the advancing clamp stem is pressed into the conical seat on the bending tool, the bending tool is securely clamped to the tool exchange device. With regard to the robotically moved tool exchange device, the conical seat, the oval seat and the oval through-bore made at the gripping point on the tool body of the bending tool are prepared with dimensions and arrangements matching the connected structural elements of the tool exchange device.

The objectives of the invention can be achieved by the bending tool as described.

Described is a bending tool for connection to a tool exchange device mounted on a robot, comprising a shoulder, a tool holder groove and a clamping groove on the tool body, comprising:
an oval bore going through the tool body below the shoulder, and
the tool holder groove side of the tool body having an oval seat extending into the oval through-bore, at the end of which, the end going into the tool body, is a flange extending vertically beyond the oval through-bore.

The clamping groove side of the tool body having a conical seat with cylindrical end sections extending into the oval through-bore, the centre line of which intersects the flange above the upper edge of the oval through-bore. The oval through-bore, the conical seat and the oval seat having dimensions and shapes matching the connected structural elements of the tool exchange device.

In an aspect of the invention, the height of the flanges at least 8 mm.

In another aspect of the invention the centre line of the conical seat intersects the flange at least 3 mm above the upper edge of the oval through-bore.

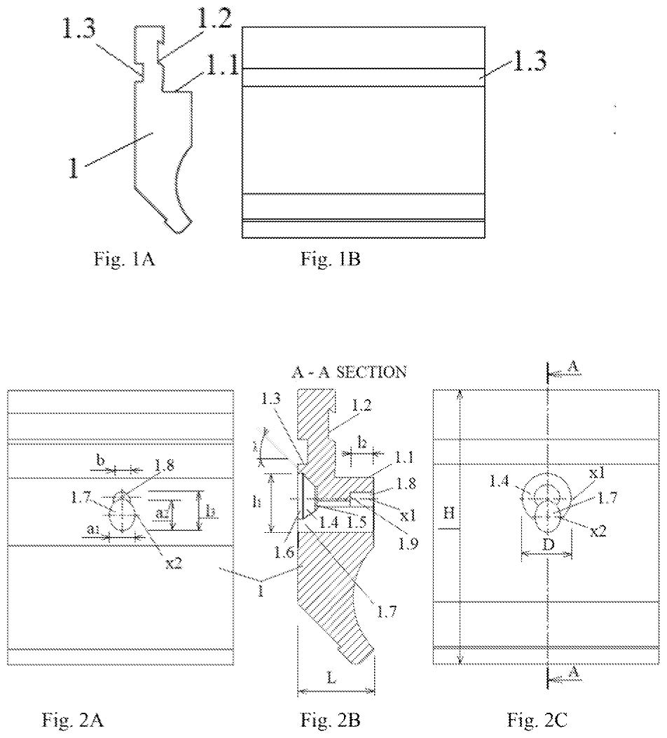

FIGS. 1A and 1B illustrate the design of a known bending tool 1 furnished with a shoulder 1.1, a tool holder groove 1.2 and a clamping groove 1.3, in two views where the aforementioned structural parts are used to store the bending tool 1 in a tool holder, and to accommodate it in the tool holder of a bending machine. As shown in the figures, the bending tool 1 is not equipped with a gripping point that would allow it to be safely gripped by a tool exchange device.

FIGS. 2A, 2B and 2C show several views of the layout of the gripping point on the tool body. FIG. 2A shows the bending tool in front view. The central part of the tool body of the bending tool 1 is designed with an oval through-bore 1.7 with centre line x₂, as well as a conical seat 1.4 with centre line x₁ and a given diameter D.

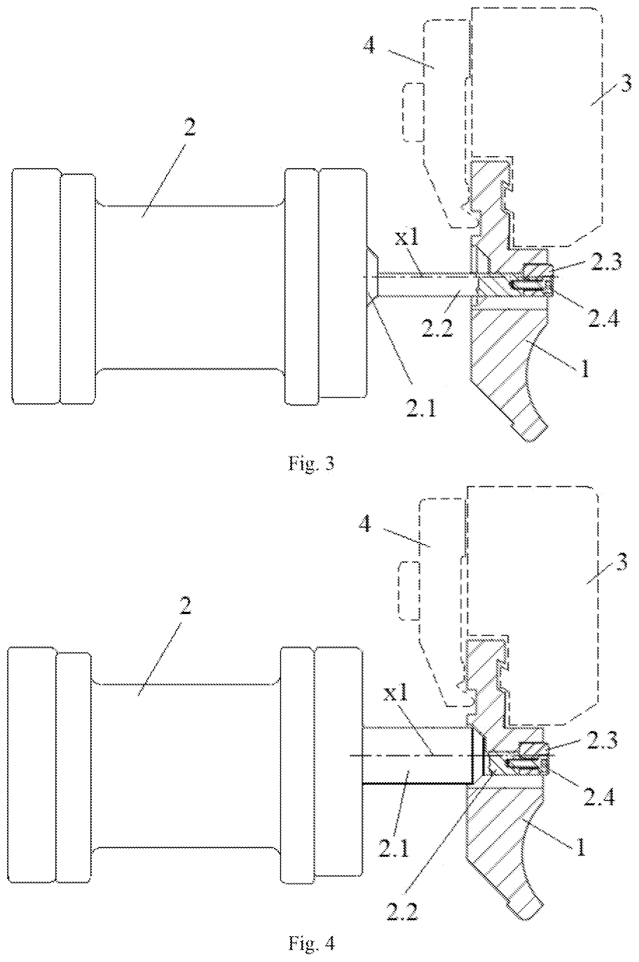

FIG. 2B shows the A-A sectional view from the centre line of FIG. 2A. On the tool holder groove 1.2 side of the bending tool's 1 tool body with given thickness L, there is an oval seat 1.8 penetrating into the oval through-bore 1.7 located under the tool shoulder 1.1 of the bending tool 1. The oval seat 1.8 is designed to accommodate the support head 2.3 mounted on the grip stem 2.2 of the tool exchange device 2, and is shaped to fit the support head 2.3 (see FIGS. 3 and 4). At the end of the oval seat 1.8 extending into the tool body is a flange 1.9 which the support head 2.3 collides with, whereby the support head 2.3 is gripped by the end of the grip stem 2.2 of the tool exchange device 2 and inserted into the oval seat 1.8. The depth h of the oval seat 1.8 is the same as the length of the support head 2.3.

On the clamping groove 1.3 side of the tool body, there is a conical seat 1.4 with centre line x1, cone angle λ, diameter D, and cylindrical end sections 1.5 and 1.6, partially penetrating into the oval through-bore 1.7. The centre line x1 of the conical seat 1.4 is parallel to the centre line x2 of the oval through-bore 1.7, but their arrangement is eccentric. The conical seat 1.4 is designed to accommodate the end of the cylindrical clamp stem 2.1 of the tool exchange device 2 (see FIGS. 3 and 4) and fits snugly against it, therefore its cone angle λ is the same as the cone angle of the end of the clamp stem 2.1, but its diameter D should be at least 1 mm larger than the diameter of the end of the clamp stem 2.1. The frontal height 11 of the bending tool's 1 gripping point shall be determined so that the centre line x1 of the conical seat 1.4 should intersect the flange 1.9 at least 3 mm above the top edge of the oval through-bore 1.7, thereby ensuring that the clamp stem 2.1, when pressed into the conical seat 1.4, presses the support head 2.3 mounted on the grip stem 2.2 against the flange 1.9. FIG. 2C shows a rear view of the bending tool 1, indicating the dimensions of the gripping point. The rear height b of the gripping point of the bending tool 1 shall be such that the height of the flange 1.9 extending vertically beyond the oval through-bore 1.7 should be at least 8 mm. The width a₁ and height a₂ of the oval through-bore 1.7 shall be determined such that the tool exchange device's 2 grip stem 2.2 equipped with the support head 2.3 (see FIGS. 3 and 4) can be inserted through the oval bore 1.7 without obstruction, and with a gap of at least 1 mm. The width b of the oval seat 1.8 is less than the width a₁ of the oval through-bore 1.7 to fit the support head 2.3.

FIG. 3 shows the tool exchange device 2 and the bending tool 1, before they are connected. The bending tool 1 is hooked into a tool holder 3 and secured by a tool clamp 4. The clamp stem with the conical end 2.1 is pulled into the tool exchange device 2, while the grip stem 2.2 extends from the tool exchange device 2 and its end is inserted into the bending tool 1. A support head 2.3 is affixed to the end of the grip stem 2.2 with a recessed head bolt 2.4, which is positioned in abutment with the flange 1.9 of the bending tool's 1 oval seat 1.8 (see FIG. 2).

FIG. 4 shows the tool exchange device 2 and the bending tool 1 in the final clamping position of the tool. The compressed air supplied into the tool exchange device 2 ejects the clamp stem 2.1 from the tool and presses it into the conical seat 1.4 of the bending tool 1 in a form-locking manner (see FIG. 2), whereby the bending tool 1 is firmly clamped on the tool exchange device 2 with a double-sided impact.

When changing tools on the bending machine, the tool exchange device 2 must be connected to the robotic arm in order to move the bending tool 1 with the robot. The grip stem with the support head 2.3 on the tool exchange device 2 shall be inserted into the oval through-bore 1.7 of the bending tool 1, which is designed to guide the grip stem 2.2. The support head 2.3 is then inserted into the oval seat 1.8 of the bending tool 1, and is butted against the flange 1.9 providing a support surface. Then, using the pneumatic equipment of the tool exchange device 2, the clamp stem with the conical end 2.1 must be pressed into the conical seat 1.4 of the bending tool 1 in a form-locking manner, and the bending tool 1 must be pressed onto the support head 2.3 butted against the flange 1.9. The tool exchange device 2 will then firmly hold the bending tool 1.

Next, by controlling the tool exchange device 2 with the robot, the bending tool 1 can be lifted out of the tool holder 3 and transferred to the tool clamp of the bending machine, by having the robot position the tool holder groove 1.2 of the bending tool 1 in the tool clamp. After gripping the bending tool 1 in the tool clamp, the clamp stem 2.1 of the tool exchange device 2 must be pulled back by means of compressed air and, moving the support head 2.3 outwards from the oval seat 1.8 of the bending tool 1, the grip stem 2.2 must be pulled out of the bending tool 1.

An advantage of the invention is that it offers a gripping point on a commercially available “raw” bending tool, allowing the tool to be safely gripped and moved on a robotic arm-mounted tool exchange device equipped with a fixed grip stem and a linearly movable clamp stem. The gripping point on the bending tool can be subsequently manufactured in a cost-effective way, and the tool is easy to use and maintain.

What is claimed is:

1. A bending tool for connection to a tool exchange device mounted on a robot, comprising a shoulder, a tool holder groove and a clamping groove on the tool body, comprising:
an oval bore going through the tool body below the shoulder,
the tool holder groove side of the tool body having an oval seat extending into the oval through-bore, at the end of which, the end going into the tool body, is a flange extending vertically beyond the oval through-bore,
the clamping groove side of the tool body having a conical seat with cylindrical end sections extending into the oval through-bore, the centre line (x1) of which intersects the flange above the upper edge of the oval through-bore, and
the oval through-bore, the conical seat and the oval seat having dimensions and shapes matching the connected structural elements of the tool exchange device.

2. The bending tool according to claim 1, wherein the height of the flange is at least 8 mm.

3. The bending tool according to claim 1, wherein the centre line (x1) of the conical seat intersects the flange at least 3 mm above the upper edge of the oval through-bore.

4. The bending tool according to claim 2, wherein the centre line (x1) of the conical seat intersects the flange at least 3 mm above the upper edge of the oval through-bore.
